(19) United States
(12) Patent Application Publication
(10) Pub. No.: US 2017/0169964 A1
(43) Pub. Date: Jun. 15, 2017

(54) Door Lock Switch Lockout Device

(71) Applicant: Larry Troutt, Eufaula, OK (US)

(72) Inventor: Larry Troutt, Eufaula, OK (US)

(21) Appl. No.: 14/963,341

(22) Filed: Dec. 9, 2015

(51) Int. Cl. H01H 13/04

(52) U.S. Cl. CPC H01H 13/04; H01H 2231/026

(57) ABSTRACT

A door lock switch lockout device for preventing unintentional locking or unlocking of a vehicle includes a housing that is box shaped. The housing has a top, an open bottom, an open front, a back, and opposing sides. A lip is coupled to the back and the opposing sides adjacent to the open bottom. A fastener is coupled to the lip. The housing is configured to be placed over the door lock switch of a vehicle with the door lock switch extending into an interior space of the housing through the open bottom. The fastener is configured to fasten the housing to the vehicle. The door lock switch is substantially covered by the housing to deter unintentional locking or unlocking of the vehicle. The open front allows access to the door lock switch for intentional locking or unlocking of the vehicle.

### BACKGROUND OF THE DISCLOSURE

### Field of the Disclosure

The disclosure relates to lockout devices and more particularly pertains to a new lockout device for preventing unintentional locking or unlocking of a vehicle.

### SUMMARY OF THE DISCLOSURE

An embodiment of the disclosure meets the needs presented above by generally comprising a housing that is box shaped. The housing has a top, an open bottom, an open front, a back, and opposing sides. A lip is coupled to the back and the opposing sides adjacent to the open bottom. A fastener is coupled to the lip. The housing is configured to be placed over the door lock switch of a vehicle with the door lock switch extending into an interior space of the housing through the open bottom. The fastener is configured to fasten the housing to the vehicle. The door lock switch is substantially covered by the housing to deter unintentional locking or unlocking of the vehicle. The open front allows access to the door lock switch for intentional locking or unlocking of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a door lock switch lockout device according to an embodiment of the disclosure.

FIG. 2 is a side view of an embodiment of the disclosure.

FIG. 3 is a front view of an embodiment of the disclosure.

FIG. 4 is a bottom view of an embodiment of the disclosure.

FIG. 5 is an in-use view of an embodiment of the disclosure.

### DESCRIPTION OF THE PREFERRED EMBODIMENT

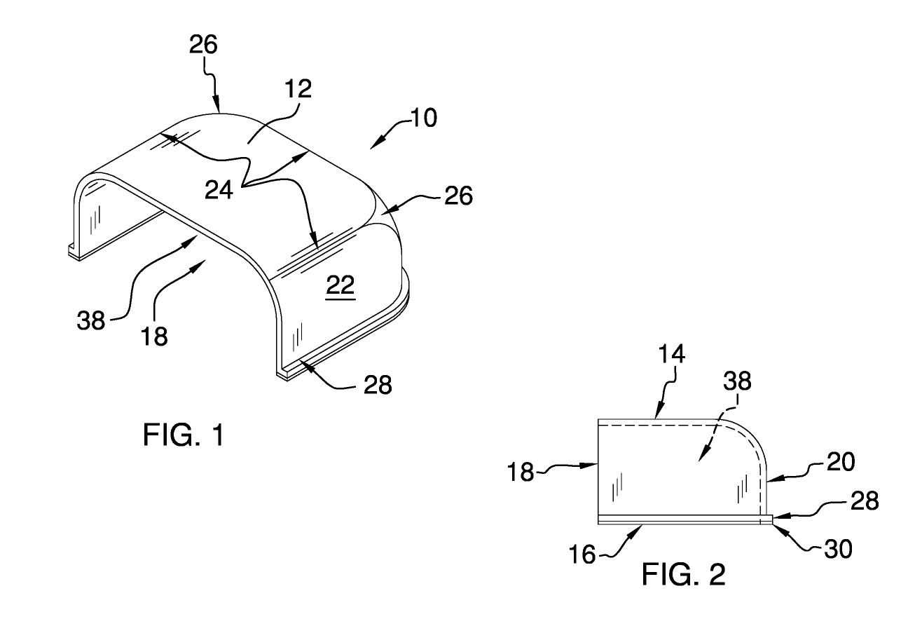

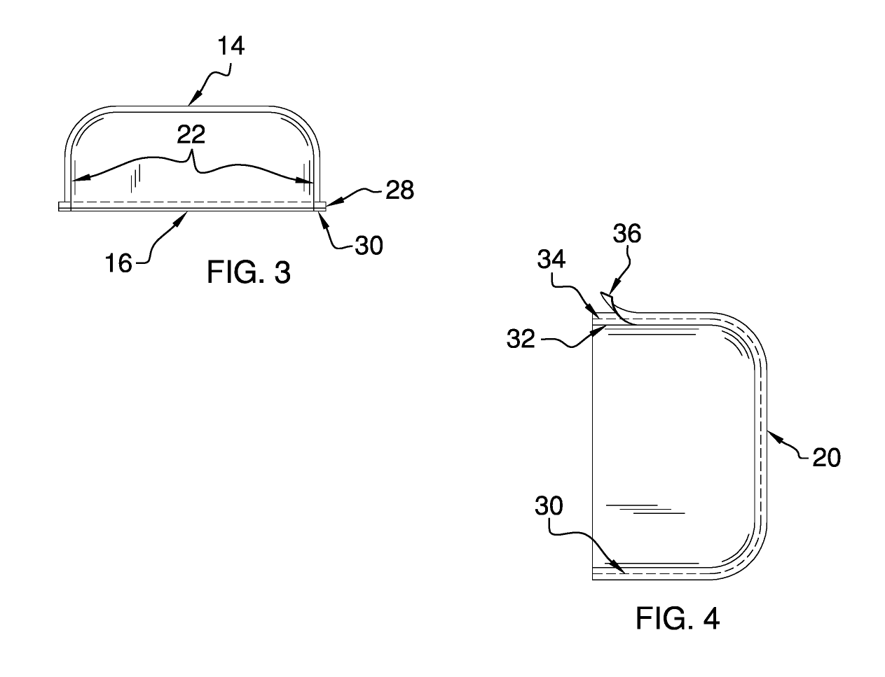

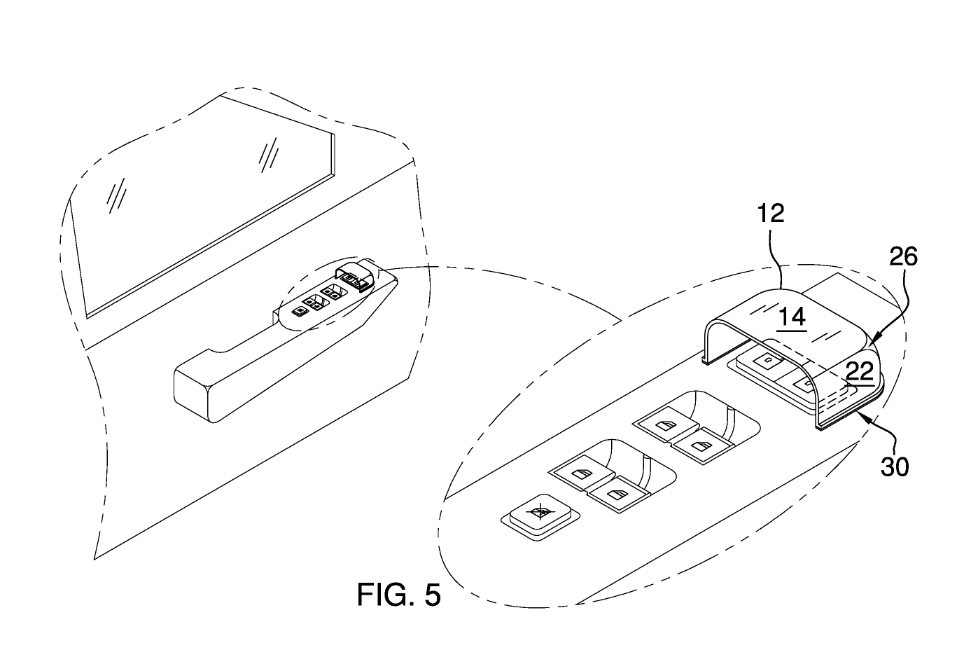

With reference now to the drawings, and in particular to FIGS. 1 through 5 thereof, a new lockout device embodying the principles and concepts of an embodiment of the disclosure and generally designated by the reference numeral 10 will be described.

As best illustrated in FIGS. 1 through 5, the door lock switch lockout device 10 generally comprises a housing 12 that is box shaped. The housing 12 has a top 14, an open bottom 16, an open front 18, a back 20, and opposing sides 22. The opposing sides 22 are dimensionally smaller than the open front 18 and the back 20. The back 20, the top 14 and the opposing sides 22 define a trio of three top edges 24 and a pair of corners 26. Preferably, the top edges 24 and the corners 26 are rounded. The housing 12 is rigid and transparent. Preferably, the housing 12 comprises plastic. More preferably, the housing 12 comprises clear, hardened plastic.

A lip 28 is coupled to the back 20 and the opposing sides 22 adjacent to the open bottom 16. The lip 28 extends outwardly from the housing 12. The lip 28 is rigid and transparent. Preferably, the lip 28 comprises plastic. More preferably, the lip 28 comprises clear, hardened plastic.

A fastener 30 is coupled to the lip 28. The fastener 30 comprises an adhesive layer 32 that is coupled to the lip 28. The adhesive layer 32 is complimentary to the lip 28. Preferably, the adhesive layer 32 comprises a tape 34 that is adhesively coupled to the lip 28. A strip 36 is reversibly coupled to the adhesive layer 32. The strip 36 is removable from the adhesive layer 32 such that the adhesive layer 32 is exposed for coupling of the housing 12 to the vehicle.

In use, the housing 12 is configured to be placed over the door lock switch of a vehicle with the door lock switch extending into an interior space 38 of the housing 12 through the open bottom 16. The strip 36 is configured to be removed by the user to expose the adhesive layer 32, wherein the housing 12 is configured to be coupled to the vehicle. The door lock switch is substantially covered by the housing 12 to deter unintentional locking or unlocking of the vehicle. The open front 18 allows access to the door lock switch for intentional locking or unlocking of the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A door lock switch lockout device comprising:
a housing, said housing being box shaped, said housing having a top, an open bottom, an open front, a back, and opposing sides;
a lip, said lip being coupled to said housing, said lip being thin, continuous, and elongated extending around said back and said opposing sides adjacent to said open bottom;
a fastener, an adhesive layer, said adhesive layer being coupled to said lip; and
wherein said housing is configured for placing over the door lock switch of a vehicle with the door lock switch extending into an interior space of said housing through said open bottom and wherein said fastener is configured to fasten said housing to the vehicle, such that the door lock switch is substantially covered by said housing to deter unintentional locking or unlocking of the vehicle, and such that said open front allows access to the door lock switch for intentional locking or unlocking of the vehicle.

2. The device of claim 1, further including said opposing sides being dimensionally smaller than said open front and said back.

3. The device of claim 1, further including said back, said top and said opposing sides defining a trio of three top edges and a pair of corners, said top edges being rounded.

4. The device of claim 3, further including said corners being rounded.

5. The device of claim 1, further including said housing being rigid.

6. The device of claim 1, further including said housing being transparent.

7. The device of claim 1, further including said housing comprising plastic.

8. The device of claim 7, further including said housing comprising clear, hardened plastic.

9. The device of claim 1, further including said lip extending outwardly from said housing.

10. The device of claim 1, further including said lip being rigid.

11. The device of claim 1, further including said lip being transparent.

12. The device of claim 1, further including said lip comprising plastic.

13. The device of claim 12, further including said lip comprising clear, hardened plastic.

14. The device of claim 1, further including said fastener comprising:
said adhesive layer being complimentary to said lip;
a strip, said strip being reversibly coupled to said adhesive layer; and, wherein said strip is removable from said adhesive layer such that said adhesive layer is exposed for coupling of said housing to the vehicle.

15. The device of claim 14, further including said adhesive layer comprising a tape, said tape being adhesively coupled to said lip.

16. A door lock switch lockout device comprising:
a housing, said housing being box shaped, said housing having a top, an open bottom, an open front, a back, and opposing sides, said opposing sides being dimensionally smaller than said open front and said back, said back, said top and said opposing sides defining a trio of three top edges and a pair of corners, said top edges being rounded, said corners being rounded, said housing being rigid, said housing being transparent, said housing comprising plastic, said housing comprising clear, hardened plastic;
a lip, said lip being coupled to said housing, said lip being thin, continuous, and elongated extending around said back and said opposing sides adjacent to said open bottom, said lip extending outwardly from said housing, said lip being rigid, said lip being transparent, said lip comprising plastic, said lip comprising clear, hardened plastic;
a fastener; said fastener being coupled to said lip, said fastener comprising:
an adhesive layer, said adhesive layer being coupled to said lip, said adhesive layer being complimentary to said lip, said adhesive layer comprising a tape, said tape being adhesively coupled to said lip, and
a strip, said strip being reversibly coupled to said adhesive layer, and,
wherein said strip is removable from said adhesive layer such that said adhesive layer is exposed for coupling of said housing to the vehicle; and
wherein said housing is configured for placing over the door lock switch of a vehicle with the door lock switch extending into an interior space of said housing through said open bottom and wherein said fastener is configured to fasten said housing to the vehicle, such that the door lock switch is substantially covered by said housing to deter unintentional locking or unlocking of the vehicle, and such that said open front allows access to the door lock switch for intentional locking or unlocking of the vehicle.
